(19) United States
(12) Patent Application Publication
(10) Pub. No.: US 2018/0361390 A1
(43) Pub. Date: Dec. 20, 2018

(54) Garbage Gobbling Means

(71) Applicant: Donna K. Jackson, Fort Worth, TX (US)

(72) Inventor: Donna K. Jackson, Fort Worth, TX (US)

(21) Appl. No.: 15/870,786

(22) Filed: Jan. 12, 2018

Related U.S. Application Data
(60) Provisional application No. 62/445,675, filed on Jan. 12, 2017.

(51) Int. Cl. B02C 18/00; B02C 21/02

(52) U.S. Cl. CPC B02C 18/0092; B02C 21/02

(57) ABSTRACT

Various embodiments of a poly-chimeric—portable, modular, waterless, electrical device to puree/pulverize food waste on site in restaurants, groceries and any other place where food waste need disposing. Also offered for consideration is a blade-means using CVT-driven cycling, and sustainable units powered by solar means. Also developed are kiosks, improved motor systems and blades, plant stock processing and methods and integrated distribution and housing centers with the same.

### CROSS REFERENCE TO RELATED APPLICATIONS

This application claims the benefit of, and priority to, U.S. Provisional Patent Application Ser. No. 62/445,675 filed on Jan. 12, 2017, the content of which is incorporated herein by reference herein in its entirety.

### BACKGROUND OF THE DISCLOSURES

The garbage gobbler device is designed to be a portable, modular, waterless, electrical device to puree/pulverize food waste on site in restaurants, groceries and any other place where food waste needs disposing.

The original design called for a series of tubes that would fill up as the waste material was ground. The newest design/s is set in motion with more up-to-date changes for both efficiency and safety.

The system is designed so the top of the device houses all the gears, motors, pulleys and such. This top housing is designed to “lift off” in case of any malfunction; a new motor top can easily be replaced with very minimal down time.

To my knowledge, this sets our device apart from all the other similar devices having this modular quality.

### OBJECTS AND SUMMARY OF THE INVENTION

Upon replacement of the top motor housing, safety latches are being installed so the motor system will not engage until perfectly aligned and safety latched. This will be accomplished through various means of electronics, switches, led lights, connectors. Safety alignment grooves and other means to ensure safety before motor will engage.

The motor system will be from 0.5 HP-20 HP depending upon the needs of the equipment and waste to be processed.

The motor will be AC, DC, variable speed, reverse motor and any other motor means needed to process the waste in a pureed pulverized manner.

The box design will be approximately 33″×34″×20″. The front of the box will have doors that open for easy access to the recyclable container/s. (see drawing 1 attached)

The box will be geared to work with switches, weighted systems, wireless control, continuous, alternating, variable, increased/decreased torque/rpm's for the likes of bones and slower rpm/torque for soft foods.

The box will have a retractable chord for easy storage

The front doors will have a blinking led light, buzzer, flash etc. to alert when the containers are nearing full. There will also be a safety shut off switch which will prevent overflow and the likes.

Inside the box the containers/bags will sit on a trolley like rolling tray/cart that is easily rolled out in order to roll a new set of containers/bags into place.

The cart will either have a handle attached or a handle for easy transport will be placed on the inside or outside of the box.

### BRIEF DESCRIPTION OF THE DRAWINGS

Various preferred embodiments are described herein with references to the drawings in which merely illustrative views are offered for consideration, whereby:

FIG. 1 is a machine drawing of a grinding mechanism—blade means according to an aspect of the invention;

FIG. 2 is an exemplary container showing safety valves; and

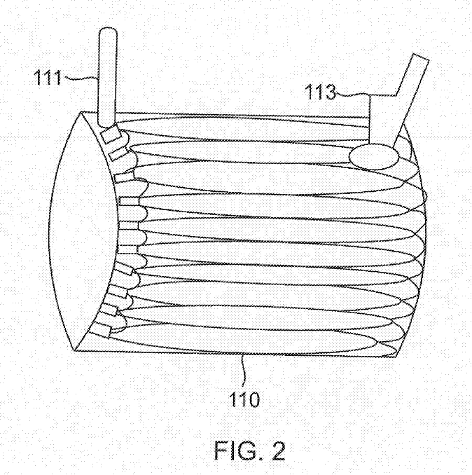

FIG. 3 is a schematic depiction of some of the shapes of devices of the present invention.

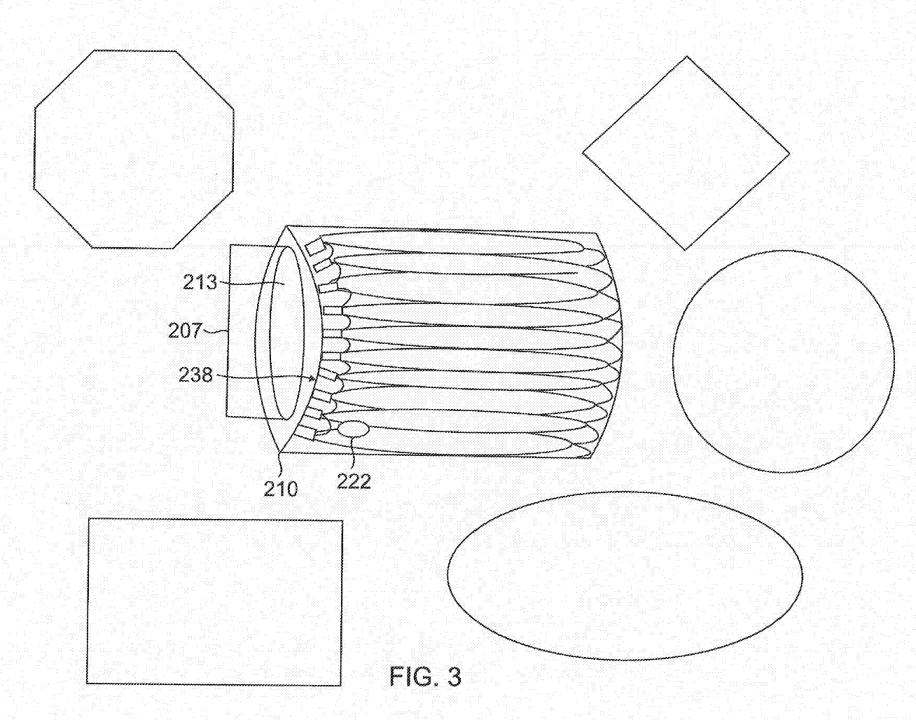

FIG. 4 is an exemplary but not limiting additional processing structure;

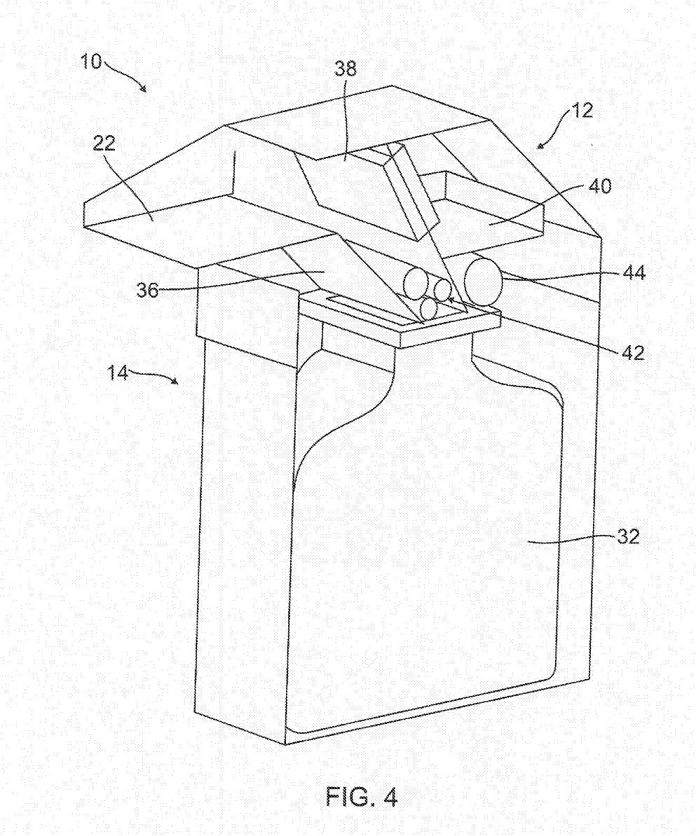

FIG. 5 is an exemplary but not limiting additional processing structure;

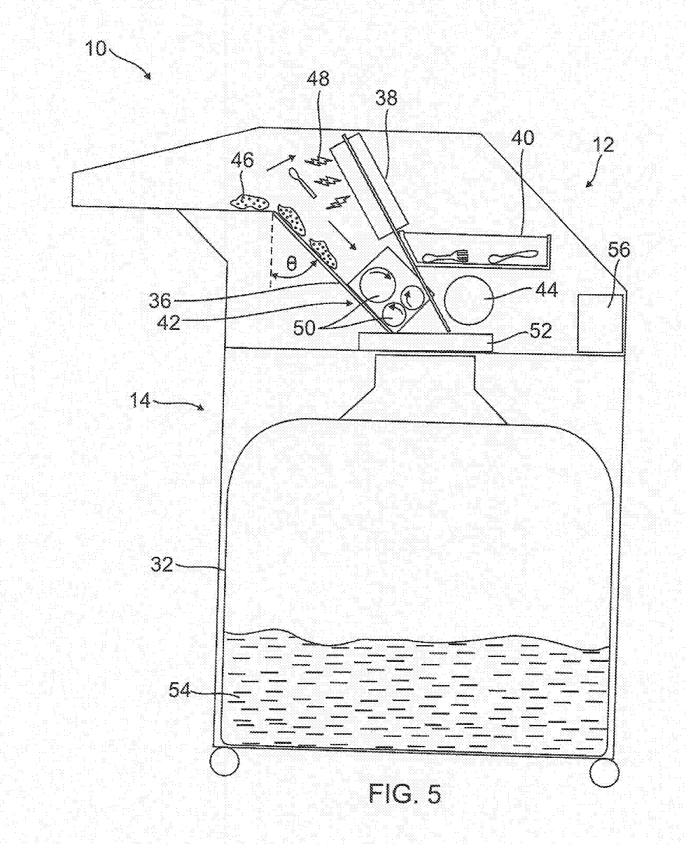

FIGS. 6A and 6B are top and bottom perspective views of one embodiment of a cutting assembly consistent with the present disclosure.

FIG. 7 is a front perspective view of the apparatus of FIG. 1 illustrating the removal of a receptacle from the bottom housing member.

FIG. 8 is a perspective view of one embodiment of a receptacle for use with the apparatus of the present disclosure.

### DETAILED DESCRIPTIONS

### Motor System and Blades

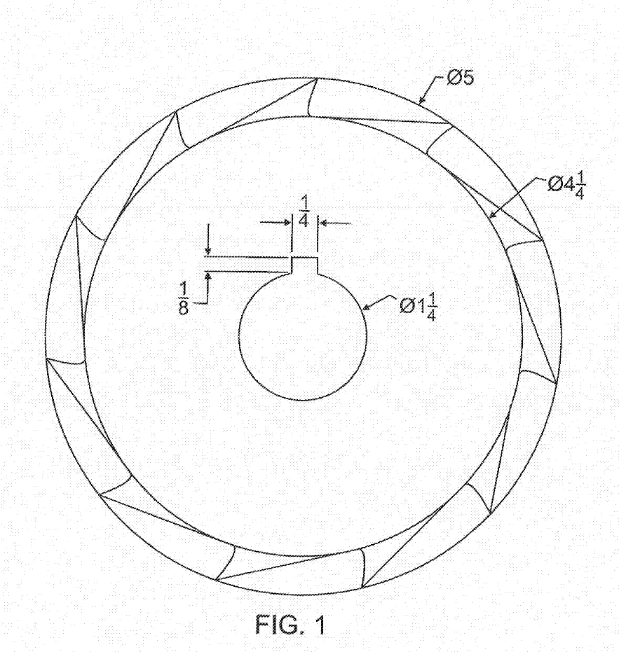

Referring now also to FIG. 1, the current motor system is a 1.5 HP reverse motor using 110 volts. The 8 blades on 1 side and the 9 on the other are affixed to a 1.25 keyed stainless steel axle rod. The blades are 5 H inches tall with ⅜″ cut blades. There are 18 teeth on each blade. This has proved ideal for this round of prototyping. Eventually they will be smaller and larger. The blades are separated with a round plastic nut allowing the width of each blade to fit and turn as close to each other leaving very little space in between.

The blade teeth are all offset slightly

Each blade is separated by a washer to allow maximum contact to the next blade

9 blades are axle positioned on 1 side and 8 on the other

The axle rods are housed between 2 pillow blocks locked together

Each axle rod is connected via a gear pulley/shaft and belt which is then connected to the 1.5 hp motor.

On the edge/side of the housing will be another set of fine blades interconnected like a bristle brush which is used to keep the blades cleaned and the food from sticking

The motor will also be variable speed to accommodate varying types of food

According to examples only, and not limiting is one embodiment, wherein—

The device itself will could range in size from 1′×1′×1′ to 100′×100′×100′ in varying geometric shapes and sizes

The motor/s will range from 0.5 HP with various rpm ability up to but not limited to 50 hp including generators and solar energy

The blades will range from 1″ circumference up to 3½ feet in circumference

The axis rods will range from ¼″ OD to 1 ft OD with length from 6″ up to 5 ft.

The blades will be various metals including stainless steel with varying types of blade teeth on the sides

The tips will be straight edge, claw, carbon tipped consisting of various types of metals

The pillow blocks will range in coordination to the varying axis rods

### Recyclable Container/s

While the current patent calls for cylinders as collections objects for the food waste, it has been discovered various types of geometric shaped containers are best suited going forward. Our claim going forward from many trials and discoveries would be:

Diamond, round, triangular, square, oval, octagon, hexagon and all other means of geometrical shapes could be fashioned to receive the food waste.

It has also been discovered each container/s would have a built in pop up valve for gas build up. The pop up is designed to release pressure and allow for constant air to flow or be exchanged while the container is filled with waste mass

During process discoveries it has also shown effective to have 1-10 safety valves/latches in place for the containers to fit snugly onto the necessary hoses and damps from the grinding mechanism

The container/s are designed with a safety feature which will only the allow the machine to start when the container/s are securely locked into place and properly connected to the main flow valve from the grinder blades, (see drawing #2)

Further discoveries, the container/s may or may not be designed with a colander type apparatus to separate the food particles from the fluid mass. This colander device would be made from the likes of metals, carbon, polyurethanes, cloth, plastics of materials known or yet to be discovered of any nature and/or combinations thereof.

In this same discovery it has shown useful to have the container/s with the colanders manufactures with a hose connection or other type of draining method to separate the fluids from the waste content/s. For example, this fluid could either be drained into a floor drain, into another container/s or disposed of or repurposed in most any necessary or desired fashion.

The container/s may or may not be reusable, recyclable, geometric shapes, sizes or it may or may not be in combinations with bags, boxes or cylinders in sizes and shapes which hold amounts ranging from 0.5 lbs. to TONS of both liquid and emulsified food waste/s.

### Kiosk Type Device for Remote Location/s

As more and more countries begin to see food waste as a problem and drought situations coupled with remote areas being able to get fuel or electricity it is inevitable technology will allow for ethanol and energy plants in various areas of the world to use food waste, grass cuttings, paper, cloth, plant and the likes. This waste/debris can and will be used for generating electricity and fuel such as bio diesel, ethanol and the likes. (See drawing #3)

Having a “place or device” in which to deliver said items where those items could be pulverized, mixed etc. would provide the necessary contents to industrial plants which provide/generate the electrical and fuel use, it would also help clean up countries where trash is a huge problem.

Ex, when there is a fuel or electrical plant in India, the Kiosk drop off for trash and the likes could pay people vouchers for their trash based upon weight much like those used today for aluminum cans etc. Those vouchers, depending upon the area/needs could be used for fuel, electricity or cashed in for money. It would get people to stop throwing trash in the streets and collecting it for the kiosk instead.

This kiosk would be run on solar energy/generators depending upon location/s and need/s. This would also help create local jobs, help the environment and allow certain governments to become financially improved.

The drawing will show a box type design with either a top or front feeder, much like a present day garbage truck that is filled and then crushes the contents. The kiosk would be designed to pulverize/puree the debris into small particles easily transportable to the proper industrial site/s. The particles can also be separated from any liquid/s through a drain hose at the bottom. The kiosk could either be lifted as a whole unit or taken to the processing site to be utilized or the contents could be syphoned out, much like a septic tank or similar devices would be emptied.

The tank would be sanitized with “user” friendly liquids, pellets or the likes as needed to maintain sanitary conditions deemed necessary by the receiver/s.

### Device for Flowers, Plant/Herbal Growers, Vinyards, Orchards and the Ukes

Much like the aforementioned kiosk, a similar device would be designed for onsite pulverizing of plant stock, grasses, fruits, vegetables and all other products of similarity. The disposal of such debris into trash bags, dumpsters, landfills, sides of road etc. could be virtually eliminated. This same material would be utilized and repurposed either as compost, fuel or electricity. (See drawing #4)

The usefulness of this device onsite could be utilized in the following:

Containers could be designed to encompass the “clippings or plant type debris” into containers that are already dilled with a measured/determined amount of liquid compost. As the plant like materials are pulverized by the grinder that material would mix with the liquid compost creating a reusing/repurposing on site or allowing for the compost to be sold.

The container/s will also be designed for easy transport to specified industrial plants including compost companies.

Marijuana growers often face several challenges with clipping disposal and such depending upon each states rulings. This device where the clippings etc. would fall into a container/s with liquid compost would render the debris unusable by consumers for smoking etc. and would give the growers the opportunity to reuse/repurpose the debris as compost or sell to the public as compost as well. There are also companies using the hemp debris to make bricks etc. this would be great way to safely sell the pulverized/powdered debris.

### Cruise Ships

Trash disposal on cruise ships is really a problem. Often waste is dumped into the ocean and some ports do not have enough landfill room to accommodate the massive amounts of trash bags. A modified version of the gobbler would allow for:

Easier more compact storage with stackable containers

Some ports actually have ethanol plants in their countries or compost companies

The pureed waste would be much easier to dispose of that bulk food waste

The gobbler containers will decrease trash bulk by 60-70%

### Innumerable Places of Usage for the Gobbler

The amount of food waste from buffets, banquets, prep tables, unused portions of baking materials etc. could be repurposed into product material suitable for ethanol or compost plants. Such as:
Universities, hospitals, military
Hotels, Casinos
Amusement parks
Athletics venues
Airports,
Trains
Fast food
Food processing plants
Brewers
Convention centers
Malls, theaters
Large department stores such as Walmart etc.

### Distribution Center

The ultimate goal for the gobbler would be a central distribution center where the containers are brought and dumped into a large crushing device. This devise would be able to separate the plastic from the containers by way of allowing the containers to fall into 1 side and the fluid collect on the other. The containers would be taken to be recycled into more containers and the fluid would be delivered to the ethanol or compost companies. (See drawing #5).

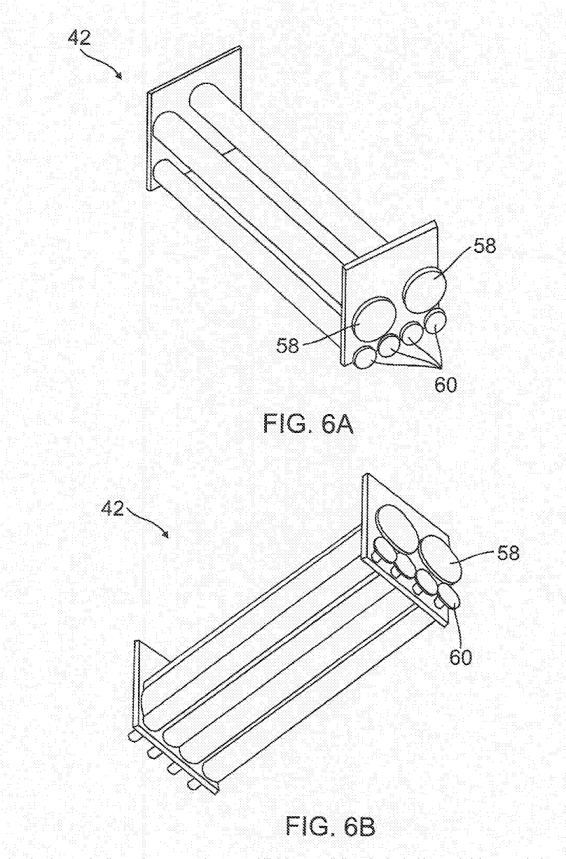

FIGS. 6A and 6B are top and bottom perspective views of one embodiment of a cutting assembly 42 consistent with the present disclosure. As previously described, the cutting mechanism 42 may resemble a roll mill having different rollers 58, 60 configured to cut, shear, grind, or otherwise pulverize the refuse.

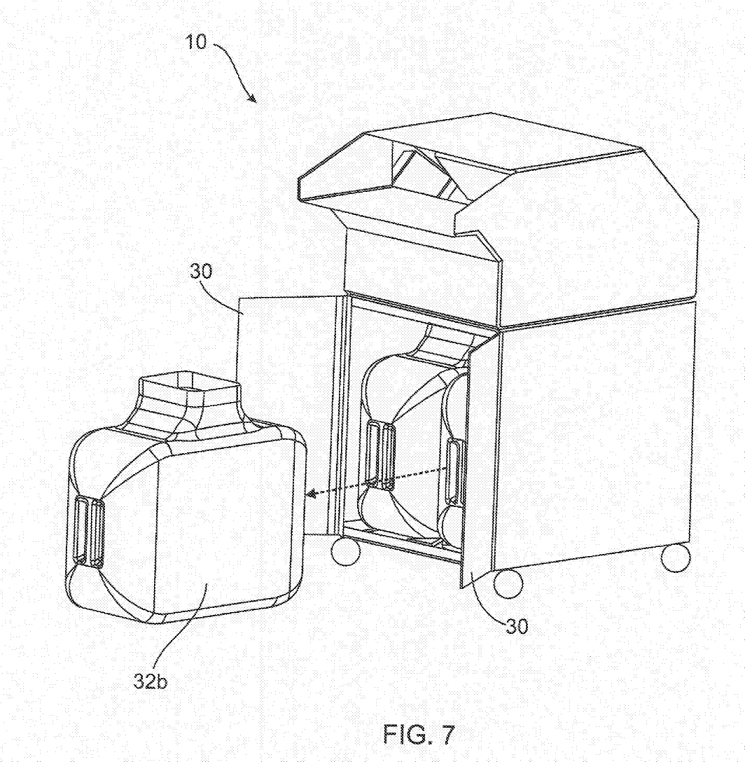

FIG. 7 is a front perspective view of the apparatus 10 illustrating the removal of a receptacle 32 from the bottom housing member. As

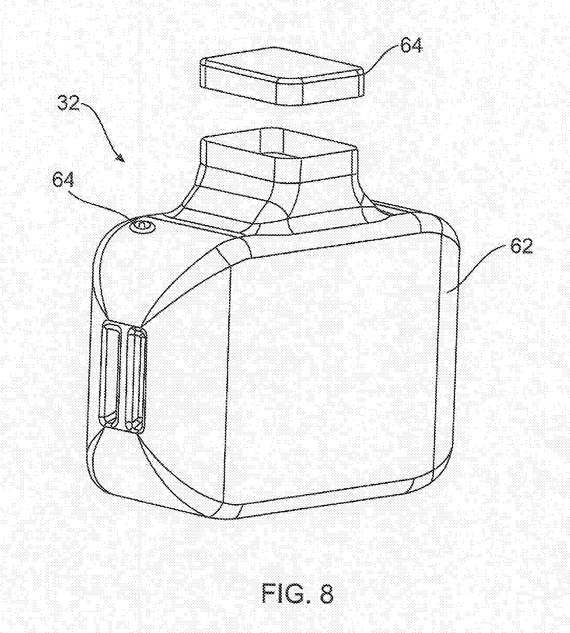

FIG. 8 is a perspective view of one embodiment of a receptacle 32 for use with the apparatus 10 of the present disclosure. As shown, receptacle 32 may include a body 62, which may include a geometric shaped canister body 62 and a corresponding lid 64 configured to cover the opening. The receptacle 32 may further include a pop-up valve 64 to provide indication of gas buildup.

### Houses and Apartments

Eventually as new housing structures are created, I envisage a type of collection process from the houses/apartments that would go into a large container underground, based upon the same concept as a septic tank. This would be metered from each dwelling so the occupants could get points on their electric bill for tonnage of food waste saved.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or dearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise dearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

A processor may be provided by one or more processors including, for example, one or more of a single core or multi-core processor (e.g., AMD Phenom II X2, Intel Core Duo, AMD Phenom II X4, Intel Core IS, Intel Core i& Extreme Edition 980X, or Intel Xeon E7-2820).

An I/O mechanism may include a video display unit (e.g., a liquid crystal display (LCD) or a cathode ray tube (CRT)), an alphanumeric input device (e.g., a keyboard), a cursor control device (e.g., a mouse), a disk drive unit, a signal generation device (e.g., a speaker), an accelerometer, a microphone, a cellular radio frequency antenna, and a network interface device (e.g., a network interface card (NIC), Wi-F card, cellular modem, data jack, Ethernet port, modem jack, HDMI port, mini-HDMI port, USB port), touchscreen (e.g., CRT, LCD, LED, AMOLED, Super AMOLED), pointing device, trackpad, light (e.g., LED), light/image projection device, or a combination thereof.

Memory according to the invention refers to a non-transitory memory which is provided by one or more tangible devices which preferably include one or more machine-readable medium on which is stored one or more sets of instructions (e.g., software) embodying any one or more of the methodologies or functions described herein. The software may also reside, completely or at least partially, within the main memory, processor, or both during execution thereof by a computer within system, the main memory and the processor also constituting machine-readable media. The software may further be transmitted or received over a network via the network interface device.

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. Memory may be, for example, one or more of a hard disk drive, solid state drive (SSD), an optical disc, flash memory, zip disk, tape drive, “cloud” storage location, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); and optical disks (e.g., CD and DVD disks).

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. Improved system and means for receiving, transporting and processing food waste into materials having value; comprising, in combination:
at least grinding mechanism such as at least a processor driven blade set;
whereby a receptacle houses materials that are continuously variably processed, meaning the blade speed is drive-in by a control system designed to spin continuously and adjust by material or signals;
intake vessels and ingress and egress assemblies;
docking, housing and further processing devices and described and claimed in the appendix;
whereby electricity ethanol and biofuel are generated and compost.

2. The improved system and means of claim 1 as disclosed herein, further comprising:
various types of geometric shaped containers selected from the group consisting of:
diamond, round, triangular, square, oval, octagon, hexagon and all other means of geometrical shapes could be fashioned to receive the food waste; wherein the material of the containers may be plastic, wax, paper or any other material capable of holding liquid/pulverized particles of food waste;
optimally each containers would have a built in pop up valve for gas build up, said pop up is designed to release pressure and allow for constant air to flow or be exchanged while the container is filled with waste mass.

3. The improved system and means of claim 1 as disclosed herein, further comprising:
means for maintaining free blade motion;
at least about 1-10 safety valves/latches in place for the containers to fit snugly onto the necessary hoses and clamps from the grinding mechanism.

4. The system of claim 3, wherein said means comprises brushes.

5. The system of claim 3, wherein an ecosystem approach to recycling using equipment disclosed herein.

6. In combination, a motor system and blades, with CVT function; kiosks for housing intake vessels in remote locations; plant stock modifications functioning with the instant system and modular housing, distribution center, and cooperative interplays with users based upon sustainable and energy positive conduct.
